(19) United States
(12) Patent Application Publication
(10) Pub. No.: US 2011/0166692 A1
(43) Pub. Date: Jul. 7, 2011

(54) METHOD FOR COOLING AND LUBRICATING A TOOL AND FOR CLEANING THE MACHINED SURFACE

(75) Inventors: Wolfgang Horn, Goppingen (DE); Waldemar Haus, Winnenden (DE); Siegfried Schmalzried, Vaihingen/Enz (DE)

(73) Assignee: MAG IAS GMBH, Goppingen (DE)

(21) Appl. No.: 12/989,738

(22) PCT Filed: Apr. 4, 2009
(86) PCT No.: PCT/EP09/02498

§ 371 Date: Oct. 26, 2010

(30) Foreign Application Priority Data
Apr. 26, 2008 (DE) 10 2008 021 049.8

(51) Int. Cl. G06F 19/00

(52) U.S. Cl. 700/160

(57) ABSTRACT

In a method for cooling and lubricating a tool during a chip-producing machining of a workpiece and for cleaning the machined surface, a cooling and lubricating agent is fed to the machined surface via the tool during machining, and after machining, supercritical CO₂ is supplied via the tool.

The invention relates to a method according to the preamble of claim 1 and to a tool spindle according to claim 3.

A method of cooling a chip-cutting, rotating tool is known from DE 102 20 526 A1 where a coolant is supplied during machining via an internal channel of a tool spindle and via a through-channel in the tool. When the machining procedure is finished, the coolant supply is interrupted. The coolant used is supercritical CO₂. The cooling effect is satisfactory. The lubrication, which is usually required during machining, is however not satisfactory. Furthermore, the machined surface, usually drill holes, needs to be cleaned afterwards. A similar method is known from GB 820,308.

A method of cleaning cavities, in other words usually drill holes, in workpieces is known from DE 10 2005 034 634 B3 where supercritical CO₂ is introduced into the cavity in order to flush the cavity. After the flushing of the cavity, the supercritical CO₂ situated in the cavity expands so as to form carbon dioxide gas and carbon dioxide snow in the cavity which are then discharged from the cavity. Introducing the supercritical CO₂ into the cavity is performed using extension poles which are introduced into the cavity. This requires a substantial amount of effort in terms of equipment and production.

It is known from DE 199 15 619 A1 that the chips, which may be loaded with small amounts of a lubricant as a result of minimum quantity lubrication when machining a workpiece, are removed by a gas flow supplied to the machined area from outside, the gas flow containing solid CO₂ particles. With this method, a reliable cleaning of the machined area is not possible.

It is known from DE 43 09 134 A1 to supply lubricant and coolant separately from outside to an area of a workpiece to be machined using a tool. With this method, a reliable minimum quantity lubrication on the one hand and a cleaning of the machined area after machining on the other hand is not possible.

It is the object of the invention to provide a method of the generic type which provides a constructionally simple manner to perform cooling and lubrication during the machining process and a cleaning process afterwards; it is another object of the invention to provide a suitable apparatus to perform this method.

This object is achieved according to the invention in a method according to the preamble of claim 1 by the features cited in the characterising part thereof. The gist of the invention is that a conventional cooling and lubricating agent is supplied via the machining tool itself during the machining process in the usual manner so as to perform a conventional minimum quantity lubrication, for example. When the machining process is finished, which is usually when the tool is removed from the workpiece, supercritical CO₂ is supplied via the tool instead of the cooling and lubricating agent, the supercritical CO₂ being used to discharge chips, residual amounts of grease and other dirt particles. The tool will still perform a controlled rotational movement during this cleaning process, causing the impurities, such as oil, residual amounts of workpiece material, greases and the like, to be subjected to sliding blast, oblique blast and impact blast processes. An additional effect is due to the sublimation expansion of the CO₂ gas. All these effects combined cause impurities to be removed to detach from the surface, thus allowing them to be removed. The CO₂ gas cools down very rapidly during expansion, causing carbon dioxide crystals, in other words dry ice, and gaseous carbon dioxide to form. This mixture is directed through the tool onto the machined surface. A huge advantage is that the tools themselves do not require any changes, thus allowing further use of all known and conventional precision tools.

There are only few additional measures to be performed on a tool spindle, which are set out in claim 3.

Further features, advantages and details of the invention will become apparent from the ensuing description by means of the drawing in which

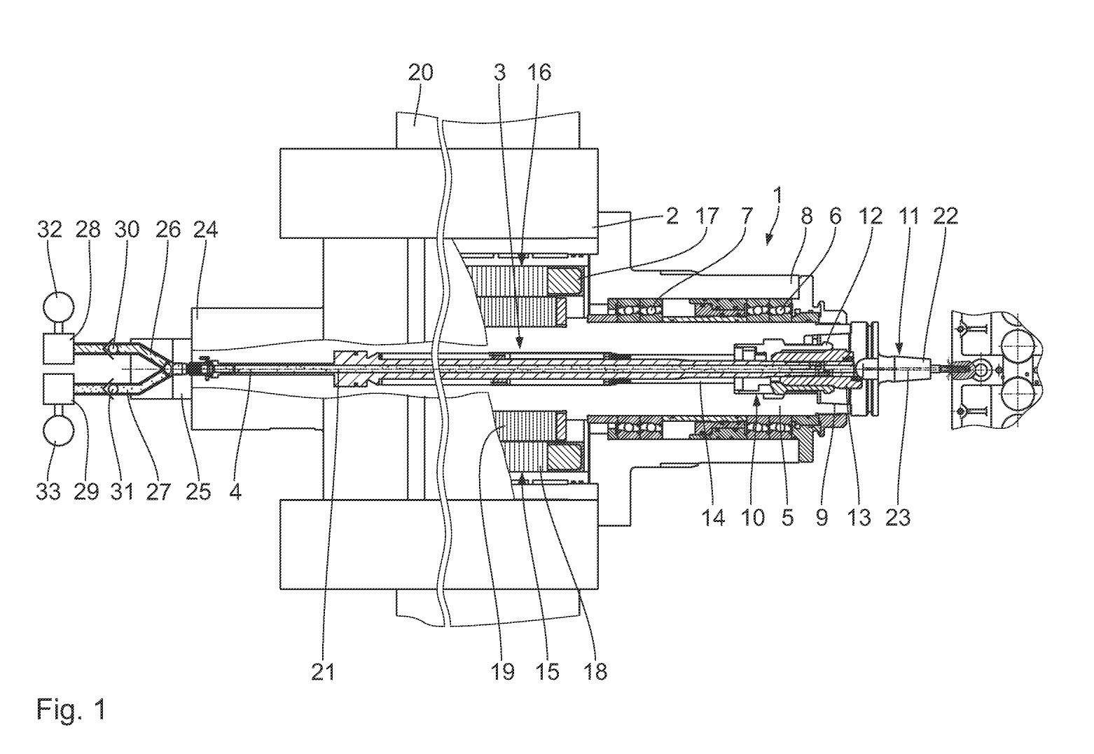

FIG. 1 shows a longitudinal section through a tool spindle according to the invention;

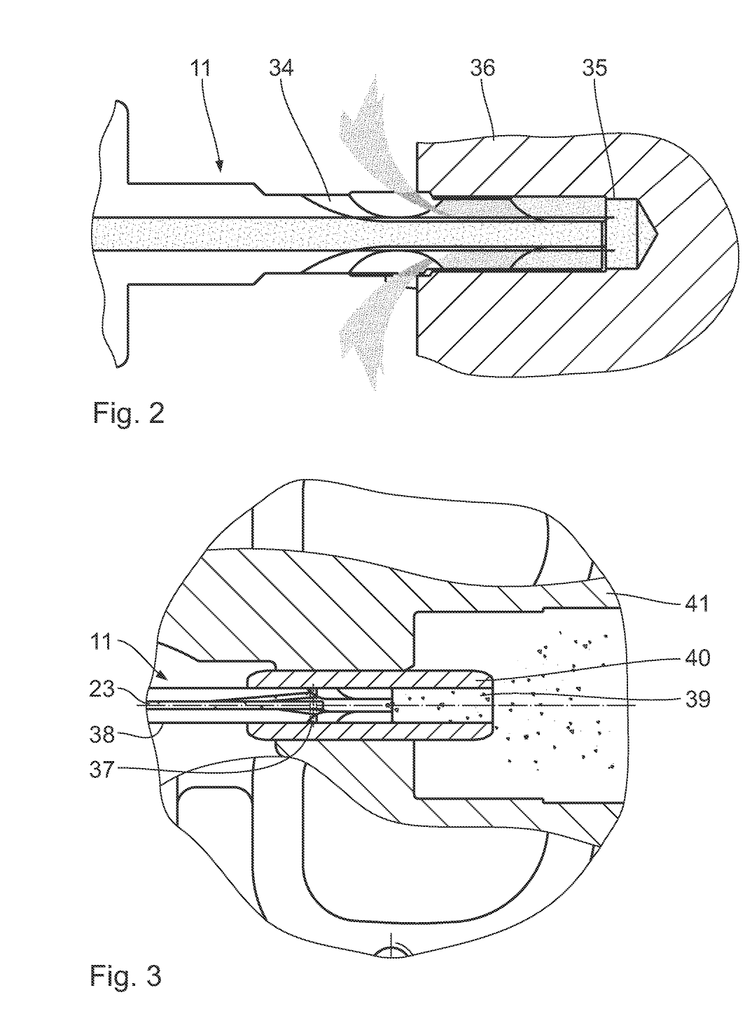

FIG. 2 shows a machining example according to the invention; and

FIG. 3 shows another machining example according to the invention.

The tool spindle 1 shown in the drawing comprises a housing 2 in which a shaft 3 is arranged that is mounted for rotary drive about a central longitudinal axis 4. On its front end, the shaft 3 is mounted in a substantially cylindrical front portion 8 of the housing 2 by means of roller bearings 6, 7.

On the front end 5 of the shaft 3 is arranged a tool holder 9 allowing a tool 11 to be firmly clamped by means of a tool clamping device 10. The clamping device 10 comprises clamping jaws 12 which are spreadable using a clamp bolt 13. The clamp bolt 13 is actuable using a tie bar 14 passing coaxially through the shaft 3. Clamping devices 10 of this type are known from common practice and for instance disclosed in DE 196 29 991 A1. A tie bar 14 of this type is usually preloaded in a direction away from the tool holder 9 by means of a preloaded spring, causing the tool 11 to be held tightly in the clamping jaws 12 of the tool holder 9. In order to release the clamping jaws 12 for changing tools, the tie bar 14 is moved in the opposite direction, i.e. toward the tool holder 9, thus allowing the clamping jaws 12 to be opened by means of the clamp bolt 13 and the tool 11 to be removed.

Further mounted in the housing 2 is a spindle rotary drive 15 (only schematically outlined) which is an electric motor. The stator 16 thereof is axially and tangentially fixed in the housing 2, in other words it is mounted in a non-rotational manner. Between the coil ends 17 of the stator 16 is arranged the laminated core 18 of the stator. The laminated core 19 of the rotor is mounted in a non-rotational manner on the shaft 3.

The housing 2 of the tool spindle 1 is supported in a machine tool 20 (only schematically outlined).

In the hollow tie bar 14 is arranged a tubular internal channel 21 which is guided up to the tool holder 9 and rests tightly against a tool 11 clamped in the tool holder 9. The tool 11 in turn comprises a through-channel 23 which tightly adjoins the internal channel 21 and passes through the entire tool 11 up to the tool tip 22 thereof.

On the rear end 24 of the shaft 3 facing away from the tool holder 9 is arranged a so-called rotary feeder 25 for free-flowing media, with two lines 26, 27 opening into said rotary feeder 25 wherein a switchable valve 28 or 29, respectively, is arranged in each of said lines 26, 27. The line 26 with the valve 28 is used for feeding in a cooling and lubricating agent while the line 27 with the valve 29 is used for feeding in supercritical CO₂. The valves 28, 29 are locked with respect to each other in such a way that they cannot be open at the same time.

In the machining example according to FIG. 2, the tool 11 is a drill 34 which is used to drill a blind hole 35 in a workpiece 36. During the drilling process, a suitable cooling and lubricating agent is transported via the line 26 with the valve 28 through the internal channel 21 and the through-channel 23 in the tool 11 up to the tip 22 thereof where it performs cooling and lubrication during the drilling process in the usual manner and helps to remove the chips.

Part of the cooling and lubricating agent may additionally also exit via transverse channels 37 in front of the tool tip 22.

When the drilling process is finished, the valve 28 is closed so as to interrupt the supply of cooling and lubricating agent 26, and the valve 29 is opened so as to feed in supercritical CO₂ via the line 27 so that at least part of which also flows up to the tool tip 22 in the manner described above where it exits. After machining the workpiece 36, when the tool 11 is being retracted from the blind hole 35, the supercritical CO₂ serves to remove impurities which are detached from the workpiece 36 due to a controlled rotation of the tool 11 and due to sublimation expansion of the CO₂ and are then discharged. Small particles, chips and residual amounts of machining oils and greases are removed from the surface of the workpiece 36 by detachment processes occurring in the gaseous CO₂.

In the machining example according to FIG. 3, the tool 11 is a rasp tool 38 used for high-precision machining of a drill hole 39 in a valve guide bushing 40. Said valve guide bushing 40 is arranged in a workpiece 41 which is a cylinder head for a combustion engine.

Between the valves 28, 29 and the rotary feeder 25 is in each case arranged one non-return valve 30, 31 which prevents one medium from flowing back into the line which is provided for the other medium In front of the valves 28, 29 are provided pressure sources 32, 33 for cooling and lubricating agent on the one hand and supercritical CO₂ on the other.

1. A method of cooling and lubricating a tool during a chip-producing machining of a surface of a workpiece and for cleaning the machined surface,
wherein a cooling and lubricating agent is supplied via the tool during the chip-producing machining of the surface,
wherein a drill hole is formed by the chip-producing machining in the workpiece,
wherein the tool is removed from the drill hole after machining, and
wherein after machining, supercritical CO₂ is supplied via the tool while the tool is being removed from the drill hole.

2. (canceled)

3. A tool spindle for a machine tool for performing a method of cooling and lubricating a tool during a chip-producing machining of a surface of a workpiece and for cleaning the machined surface,
wherein a cooling and lubrication agent is supplied via the tool during the chip-producing machining of the surface,
wherein a drill hole is formed by the chip-producing machining in the workpiece,
wherein the tool is removed from the drill hole after machining , and
wherein after machining, supercritical CO₂ is supplied via the tool while the tool is being removed from the drill hole, the tool spindle comprising:
a shaft mounted for rotary drive in a housing;
a tool holder at a front end of the shaft for holding a tool comprising a through-channel;
an internal channel in the shaft for feeding a free-flowing medium to the through-channel of the tool;
a switchable feeder for cooling and lubricating agent to the internal channel; and
a switchable feeder for supercritical CO₂ to the internal channel.

4. A Tool spindle according to claim 3, wherein the feeders open into the internal channel via a common rotary feeder at a rear end of the shaft, and that in each feeder is arranged a non-return valve in front of the rotary feeder.
